(19) United States
(12) Patent Application Publication
(10) Pub. No.: US 2012/0228236 A1
(43) Pub. Date: Sep. 13, 2012

(54) PHOTOCHEMICAL PURIFICATION OF FLUIDS

(76) Inventors: R.Thomas Hawkins, II, Aloha, OR (US); Mark D. Owen, Beaverton, OR (US)

(21) Appl. No.: 13/505,451

(22) PCT Filed: Nov. 4, 2010
(86) PCT No.: PCT/US10/55510

§ 371 Date: May 1, 2012

Related U.S. Application Data
(60) Provisional application No. 61/258,154, filed on Nov. 4, 2009.

(51) Int. Cl. B01J 19/08; C02F 1/32; B01D 53/86

(52) U.S. Cl. 210/748.14; 210/251; 422/186

(57) ABSTRACT

Apparatus and methods for the photochemical purification of fluids are disclosed. Fluids containing organic, inorganic and/or microbiological contaminants are treated by photochemical processes in a hybrid photoreactor incorporating a photocatalyst bonded to a light transmissive fiber substrate within at least a portion of the fluid and light sources to illuminate the fluid and photocatalyst. Photochemical processes include photocatalytic oxidation, photocatalytic reduction, photoadsorption, photolysis and photodisinfection. Some aspects of the disclosure include optimization of distribution of photocatalyst within the fluid, optimization of mass transport of contaminants by distribution of randomly-oriented fiber substrate, optimization of photoefficiency by control of light source wavelengths, use of LEDs to achieve optimized light source wavelengths, optimization of light delivery from light sources to fluid, and use of a microprocessor to optimize system performance.

### CROSS REFERENCE TO RELATED APPLICATION

This application claims priority to and the benefit of U.S. Provisional Patent Application No. 61/258,154, filed on Nov. 4, 2009.

### FIELD

This disclosure relates to the purification of a fluid, such as water or air, and more particularly to the removal, reduction and/or detoxification of contaminants in the fluid, such as organic chemicals, inorganic chemicals, heavy metals, microorganisms and others. The phrase “and/or” means “and”, “or” and both “and” and “or”.

### SUMMARY

Light-activated photocatalytic oxidation is an advanced oxidation process that involves the creation of nonselective, strongly oxidizing hydroxyl radicals at the fluid-photocatalyst interface that mineralize (i.e., convert to carbon dioxide) a wide range of organic compounds in water or in the presence of water. The photocatalytic process also produces reduction sites that participate in reduction of inorganic ions as well as photoadsorption of toxic heavy metals. Still further, the photocatalytic process also produces “super oxygen” ions and other species that contribute to further fluid purification reactions. Semiconductor chalcogenides (particularly oxides and sulfides) namely TiO₂, ZnO, WO₃, CeO₂, ZrO₂, SnO₂, CdS, and ZnS, have been evaluated in the past for photocatalytic effectiveness, with anatase titania (TiO₂) generally delivering the best photocatalytic performance with maximum quantum yields. Titania is known to have strong sorption affinities for heavy metals, including toxic metals such as lead, arsenic and mercury.

Photoadsorption is one example of a photo-enhanced sorption process that can efficiently remove heavy metals dissolved in a fluid to stable sorption sites on the surface of a photoactivated semiconductor material. As yet another example, illumination of a fluid such as water or air with light, especially with ultraviolet (UV) light, can directly induce breaking of chemical bonds within some first organic compounds in the fluid, forming new compounds and thereby reducing the concentration of said first organic compounds. As still another example, illumination of a fluid such as water or air with light, especially UV light, of sufficient intensity can be used to disinfect the fluid photochemically by directly killing or sterilizing microorganisms therein. As yet another example, illumination of a fluid such as water or air with light of sufficient intensity can disinfect the fluid indirectly by photothermally heating the fluid and thereby killing microorganisms therein.

A plurality of photochemical processes, such as selected from the group comprising photocatalytic oxidation, photocatalytic reduction, photolysis, photodisinfection, photoadsorption and photothermal disinfection, as well as other photo-activated processes, acting synergistically, can be used in the optimization of photochemical treatment systems. One aspect of certain embodiments of the present disclosure is the enabling of multiple photochemical processes in a photochemical fluid treatment system. A further aspect of selected embodiments in the present disclosure is to enhance and/or optimize the performance of each photochemical process enabled in a photochemical fluid treatment system to maximize synergies among the processes.

Photochemical purification processes, including photolysis, photodisinfection, photoadsorption and photocatalysis, require delivery of light and contaminants to reaction sites. Optimizing both process rate and energy efficiency involves efficiently producing and delivering light at optimum photon energy and optical flux to reaction sites while also maximizing mass transport of reagents to reaction sites. Therefore, in an effective and efficient photochemical fluid decontamination process and system it is desirable that light be produced with high electrical-to-optical conversion efficiency and that the light thus produced be delivered to reaction sites while minimizing optical loss.

In accordance with an aspect of certain embodiments, photochemical processes at photocatalyst surfaces involve the illumination of the semiconductor photocatalyst with photon energies desirably at or above, but near to, the band gap energy of the semiconductor in order to create the electron-hole pairs that effect photochemical reactions at or near the semiconductor surface. Correspondingly, the wavelength of the illuminating light is desirably at or below, but near to, the band gap energy wavelength. The photochemical reaction rate is typically linearly related to illumination flux up to a process-impeding illumination flux that depends on photon energy, semiconductor properties, reagent mass transport and other system factors. In particular, this process-impeding illumination flux is understood to result from insufficient mass transport of contaminants to the semiconductor surface for effective utilization of holes at the photocatalyst surface to oxidize the contaminants. At this process-impeding illumination flux, there is understood to be a loss of excess holes to electron-hole recombination within the semiconductor and subsequent reduced process efficiency. Optimizing performance of such a photochemical system desirably involves operating a system such that illumination of the photocatalyst is at or below this process impeding illumination flux. Desirably, in aspects of certain embodiments, illumination intensity over the surface of the photocatalyst material is desirably achieved to enhance the performance of and/or optimize such a photochemical system.

Moreover, semiconductor absorption of photons is understood to be approximately proportional to the square of the photon energy above the semiconductor band gap. Therefore, higher energy photons are absorbed nearer the surface of the illuminated semiconductor than are photons with energy nearer the band gap. As a result of this strong absorption dependence on photon energy, a broad distribution of photon energies above the band gap results in a higher effective illumination flux at the surface of a distribution of photocatalyst material than is the case for a narrower photon energy distribution. However, it has been found to be desirable to illuminate a photocatalyst in a photochemical system with a narrow distribution of photon energies from the light source that are at and/or above, but near to, the energy of the band gap to maximize penetration of the light into the photocatalyst material without exceeding the critical flux limit at the surface of this photocatalyst material.

Mass transport limits result in practical limits on both illumination flux and photochemical reaction rates. Therefore, a desirable approach that optimizes photochemical removal of contaminants from a fluid involves maximizing the mass transport of contaminant species to adsorption sites on the photocatalyst material in such a photochemical system. Maximizing available photocatalyst surface area is also desirable for an improved photochemical fluid decontamination system. In addition, turbulent flow in the fluid adjacent to a photocatalyst surface is also desirable to improve mass transport of contaminants from the fluid to the surface. Maximizing and/or enhancing turbulence in fluid flow near the photocatalyst surface is a still further desirable aspect of a method in a photochemical fluid decontamination system.

A desirable flow system in accordance with an aspect of certain embodiments of this disclosure induces microscopic turbulence in flow over a stationary photocatalyst. The specific surface area density of the photocatalyst can also be very high, such as 50 square meters per liter of fluid being treated or much higher.

A need therefore exists for a photochemical fluid treatment system that provides improved photochemical process rates and efficiencies.

Aspects of the present disclosure relate to an apparatus and method for fluid treatment that employs one or more photochemical mechanisms to provide efficient removal of multiple contaminants from the fluid. The apparatus desirably incorporates at least one treatment vessel containing a photocatalyst on a fixed porous substrate within the vessel. The apparatus desirably has a fluid inlet to the treatment vessel and a fluid outlet from the treatment vessel. The apparatus and method desirably treat fluid within the vessel by irradiating the fluid and photocatalyst with light comprising one or more wavelength bands. The apparatus and method can employ light generated by lamps, solid-state emitters and/or the sun. The apparatus and method can treat the fluid in a flowing state, wherein fluid flows from the inlet to the outlet during the treatment process, or in a stationary (e.g., a batch) state, wherein the fluid does not flow during the treatment process.

The apparatus and method disclosed herein improve on prior art, in one aspect, by significantly improving efficiency. Exemplary embodiments enable a plurality of photochemical processes to act synergistically in a single apparatus. One or more of the following features can be included in exemplary embodiments: novel light management mechanisms that improve optical coupling from the light source or sources into the treated fluid, minimize light loss due to reflection from the photocatalyst and its support within the treatment vessel, and light sources that can be in removable cartridges and/or that can be otherwise removable from intimate contact with the fluid stream for ease of service; features that improve mass transport of contaminants to photocatalyst surfaces within the treatment vessel such as through the use of a randomly oriented, narrow fiber photocatalyst substrate, with resulting increase in photochemical process rates; using fluid treated in the apparatus to carry away heat generated by the apparatus and method; features that enhance the optimization of the amount and distribution of photocatalyst within the photochemical fluid treatment vessel to maximize process rates; providing photocatalyst with a very high surface area density; and tailoring of the spectral distribution of the light used to produce electron-hole pairs within photocatalyst in the photochemical fluid treatment vessel to improve the operating efficiency of the system and to also increase the surface area of activated photocatalyst in contact with the fluid being treated.

Some embodiments of a fluid treatment photoreactor can include a housing having a fluid inlet for receiving fluid to be treated and a fluid outlet for delivering treated fluid, the housing defining a fluid flow path between the fluid inlet and the fluid outlet. An at least partially light transmissive fiber substrate can be disposed within the housing in the fluid flow path. The fiber substrate desirably has a non-uniform orientation and spacing. A semiconductor photocatalyst is disposed on (deposited onto, adhered to, coated onto, and/or otherwise connected to) the substrate and has a band gap wavelength that is approximately λ_{g}. The photocatalyst desirably has a specific surface area of more than 50 square meters per liter of fluid in the portion of the fluid flow path containing the substrate. The photoreactor can also include at least one light source that produces light, wherein at least 50% of the light from the at least one light source has a wavelength that is between (λ_{g}-30 nm) and λ_{g}.

In some embodiments, the housing can include at least one light transmitting portion operable to guide fluid flow through the photoreactor while also transmitting the light produced by the at least one light source into an illuminated portion of the fluid with less than a 10% loss of light through the light transmitting portion. The housing can constrain the illuminated portion of the fluid to have a substantially constant thickness at least in the region of the housing where the fluid is illuminated by the at least one light source.

In some embodiments, the housing can include at least first and second fluid guiding surfaces, and with an illuminated portion of the fluid of a substantially constant thickness being confined between the at least first and second fluid guiding surfaces of the housing, such as parallel planar fluid guiding surfaces. In other embodiments, the housing can include an outer cylindrical wall section and at least one inner cylindrical wall section within the outer wall section. The outer wall section can comprise an inner fluid guiding surface, the at least one inner wall section can comprise an outer fluid guiding surface, and wherein the housing constrains the fluid flow path between the inner fluid guiding surface of the outer wall section and the outer fluid guiding surface of the at least one inner wall section. In other alternative embodiments, the housing can comprise a wall section, such as a right cylindrical wall section, with a plurality of light sources and/or light guides positioned within the housing. The light sources and/or light guides can be cylindrical in shape. The housing can be in the form of a removable member, such as a cartridge, to facilitate servicing.

In some embodiments, the amount and disposition of the photocatalyst on the substrate in the housing is sufficient to absorb at least 60% of the light reaching the photocatalyst from the at least one light source.

In some embodiments, the combined volume of the photocatalyst and the substrate can be less than 1%, 2% and/or 5%, of the fluid volume in the fluid flow path within the housing.

In some embodiments, the specific surface area of the photocatalyst can be greater than 2000, 1000, 500 and/or 100 square meters per liter of fluid.

In some embodiments, light from the at least one light source can illuminate a portion of fluid and a portion of the photocatalyst in the fluid flow path with a minimum optical intensity within the illuminated portion of the photocatalyst of greater than 15% and/or greater than 10% of the maximum optical intensity within the illuminated portion of the photocatalyst.

In some embodiments, the specific surface area of the photocatalyst and the wavelength of the light from the at least one light source can be selected to obtain a minimum optical density within an illuminated portion of the photocatalyst greater than 10% of the maximum optical density within that portion of the fluid flow path.

In some embodiments, a controller can be operable to control at least one operating parameter of the photoreactor, at least one sensor is coupled to the controller and operable to sense the at least one operating parameter and produce an output signal corresponding to the sensed at least one operating parameter and the output signal is communicated by the controller to effect control of the at least one operating parameter. In some of these embodiments, the at least one operating parameter includes at least one of: a temperature of the at least one light source, a temperature of the fluid in at least one location within the photoreactor, a purity of the fluid in at least one location within the photoreactor, and a turbidity of the fluid in at least one location within the photoreactor. Indirect control of the operating parameter can be controlled by controlling another parameter. For example, if temperature of the light source is the at least one operating parameter, power to the light source can be controlled to thereby control the temperature of the light source.

In some embodiments, a controller is operable to control at least a first operating parameter of the photoreactor, at least one sensor is coupled to the controller and operable to sense at least a second operating parameter of the photoreactor and produce an output signal corresponding to the sensed at least second operating parameter and the output signal is communicated by the controller to effect control of the at least first operating parameter. In some of these embodiments, the first operating parameter includes at least one of: an electrical current supplied to the at least one light source, a fluid flow rate within the fluid flow path and a cooling fluid flow rate through a heat sink; and the second operating parameter comprises at least one of: a temperature of the at least one light source, a temperature of the fluid in at least one location within the photoreactor, a purity of the fluid in at least one location within the photoreactor and a turbidity of the fluid in at least one location within the photoreactor.

An exemplary method for treating fluid includes exposing a fluid to be treated to a semiconductor photocatalyst disposed on a fiber substrate, wherein the photocatalyst has a band gap wavelength that is approximately λ_{g} and a specific surface area of more than 50 square meters per liter of fluid. The method also includes illuminating at least a portion of the fluid to be treated and at least a portion of the photocatalyst within the fluid with light to activate at least two photochemical fluid treatment processes, wherein at least 50% of the light comprises wavelengths between (λ_{g}-30 nm) and λ_{g}. The at least two photochemical fluid treatment processes can be from the group comprising or consisting of from photolysis, photocatalytic oxidation, photocatalytic reduction, photodisinfection, and photoadsorption.

Some embodiment of a fluid treatment photoreactor can include a housing comprising a fluid inlet for receiving fluid to be treated and a fluid outlet for delivering treated fluid, the housing can define a fluid flow path between the fluid inlet and the fluid outlet. An at least partially light transmissive fiber substrate can be disposed within the housing in the fluid flow path. The fiber substrate can have a non-uniform orientation and spacing. The fiber substrate can also be at least partially uniformly oriented and/or spaced. A semiconductor photocatalyst can be disposed on the substrate with a band gap wavelength that is approximately λ_{g}. The photoreactor can also include at least one light source that produces light that interacts with at least a portion of the photocatalyst, wherein at least 50% of the light has a wavelength that is between (λ_{g}-30 nm) and λ_{g}. The photoreactor can also include a controller operable to control at least a first operating parameter of the photoreactor, at least one sensor coupled to the controller and operable to sense at least a second operating parameter and produce an output signal corresponding to the sensed at least second operating parameter. The output signal can be communicated to the controller with the controller effecting control of the at least first operating parameter.

Some embodiments of a fluid treatment photoreactor can include a housing having a treatment volume within the housing, wherein the treatment volume includes a fluid. An at least partially light transmissive fiber substrate can be disposed in the fluid within the treatment volume. A semiconductor photocatalyst can be disposed on the substrate in the fluid within the treatment volume and has a band gap wavelength that is approximately λ_{g}. The photocatalyst desirably has a specific surface area of more than 50 square meters per liter of fluid. The photoreactor can comprise at least one light source is included that produces light having a wavelength peak that is in a range from about (λ_{g}-9 nm) to about λ_{g}, wherein at least a portion of the light is transmitted into the treatment volume and at least 10% of the light from the at least one light source is transmitted to a depth of at least 1.5 cm into the treatment volume.

In some of these embodiments, the light is transmitted into the treatment volume from plural directions, such as from two opposing sides of the treatment volume. The system can be operated such that at least 20% of the light from the at least one light source is transmitted to a depth of at least 1.5 cm into the treatment volume, and/or the wavelength peak is in a range from about (λ_{g}-3 nm) to about λ_{g}.

Some embodiments of a fluid treatment photoreactor can include a housing having a fluid inlet for receiving fluid to be treated and a fluid outlet for delivering treated fluid, the housing can define a treatment volume and a fluid flow path from the fluid inlet through the treatment volume and to the fluid outlet, and the photoreactor can also include at least one light transmitting element operable to guide fluid flow through the photoreactor while also transmitting light into the treatment volume. An at least partially light transmissive substrate is disposed in the fluid within the treatment volume and the substrate can comprise fibers having random orientation and spacing. A semiconductor photocatalyst can be disposed on the substrate in the fluid within the treatment volume and can comprise a band gap wavelength that is approximately λ_{g} and can have a specific surface area of at least about 1000 square meters per liter of fluid. The photoreactor can also include at least one light source that includes at least one array of LEDs that produce light having a wavelength peak that is in a range from about (λ_{g}-9 nm) to about λ_{g}, wherein at least 50% of the light produced by the at least one light source has a wavelength that is between (λ_{g}-30 nm) and λ_{g}. At least one light transmissive light guide can also be included that conveys light from the at least one light source through the at least one light transmitting element of the housing and into the treatment volume such that at least 10% of the light produced by the at least one light source is transmitted to a depth of at least 1.5 cm into the treatment volume. The photoreactor can also include a controller that is operable to control at least a first operating parameter of the photoreactor and at least one sensor coupled to the controller and operable to sense at least a second operating parameter and produce an output signal corresponding to the sensed at least second operating parameter, wherein the output signal is communicated by the controller to effect control of the at least first operating parameter.

The disclosure herein references a number of exemplary embodiments. The inventive features and method acts include all novel and non-obvious elements and method acts disclosed herein both alone and in novel and non-obvious sub-combinations with other elements and method acts. In this disclosure, it is to be understood that the terms “a”, “an” and “at least one” encompass one or more of the specified elements. That is, if two of a particular element are present, one of these elements is also present and thus “an” element is present. The phrase “and/or” means “and”, “or” and both “and” and “or”.

### BRIEF DESCRIPTION OF THE DRAWINGS

FIG. 1 is a cut-away view of an embodiment in accordance with the present disclosure;

FIG. 2 is a cut-away view of another embodiment in accordance with the present disclosure;

FIG. 3 is a cut-away view of yet another embodiment in accordance with the present disclosure;

FIG. 4 is a graph supporting one aspect of the present disclosure;

FIG. 5 is a graph supporting another aspect of the present disclosure;

FIG. 6 is a graph yet supporting another aspect of the present disclosure;

FIG. 7 is a graph still supporting another aspect of the present disclosure;

FIG. 8 is a block diagram of an a control system in accordance with the present disclosure; and

FIG. 9 is a cut-away view of still another embodiment in accordance with the present disclosure.

### DETAILED DESCRIPTION

In accordance with desirable embodiments, one or more photocatalysts can be bonded to an at least partially light transmissive fibrous substrate in a photochemical reactor apparatus, which can be used for the disinfection and purification of a fluid, such as water or air, for commercial and industrial applications, for point-of-use markets, for cleanup of contaminated process outflow such as waste water and exhaust gases, and for environmental remediation. Of course these are just examples and one skilled in the art will recognize a wide range of additional applications of the present disclosure, including, but not limited to, producing ultrapure water for manufacturing semiconductors and pharmaceuticals, disinfecting and purifying water and air in medical and laboratory facilities, and removing biological oxygen demand and total organic carbon from waste water and greywater.

Desirably, an effective and efficient photochemical system for fluid disinfection and purification with photocatalytic functionality utilizes the delivery of sufficient illumination intensity to a photocatalyst to activate its photochemical performance, and the incorporation of sufficient photocatalyst to effectively absorb that light. Furthermore, the illuminated photocatalyst is desirably dispersed within the fluid being treated in order to purify and disinfect substantially all, or all, the fluid effectively. Still furthermore, contaminants in the fluid are substantially, if not entirely, purified and disinfected at the surface of the photocatalyst, so that it is desirable that the surface area of the photocatalyst be relatively large. It is also desirable that contaminants be delivered to that surface through mass transfer induced by turbulent flow through the photocatalyst material.

The present disclosure describes embodiments of an apparatus and method for disinfecting and purifying a fluid that is desirably presented to an inert, semi-rigid, fibrous material that is at least partially transmissive to light (i.e., the fibrous material allows at least a portion of light incident upon it to pass into and/or through the fibrous material), through which fluid can flow, and onto which one or more high-surface-area photocatalysts are adhered. The terms “light transmissive,” “transmissive to light” and the like can be defined with respect to specific light wavelengths and a specific material to mean that at least 50% of light incident on the material penetrates to a depth of 1 cm into the material or passes through the material.

Alternatively, the substrate can comprise substrates other than fibers, such as a mesh. The substrate material can be randomly oriented or at least partially aligned. Embodiments of the material described in the present disclosure and the apparatus and method for its use in photochemical disinfection and purification of fluids can be further characterized by high mass transfer efficiency resulting from turbulent fluid flow through the material with low pressure drop. Embodiments of the one or more light sources used to activate the one or more photocatalysts employed in the photochemical fluid disinfection and purification apparatus and method described in the present disclosure are still further characterized by the desirable production of light in one or more wavelength bands selected to activate the one or more photocatalysts with high energy efficiency. An optical coupling mechanism can be used to deliver light from the light sources to the one or more photocatalysts employed in the photochemical fluid disinfection and purification apparatus and method described in the present disclosure that is characterized by high optical efficiency and by an improved uniformity in the illumination of the photocatalyst.

One desirable embodiment uses a photocatalyst deposited onto, adhered to, coated onto, and/or otherwise connected to a narrow, optically transparent quartz fiber to provide improved photocatalytic performance. The photocatalyst in this embodiment can be a titania (titanium dioxide, TiO₂) nanoparticle material with a specific surface area density of >500 m² per g of photocatalyst. The quartz fiber substrate is desirably prepared as a mass of fibers with random fiber orientation and spacing. The mass distribution of the photocatalyst is therefore determined by the thickness of the photocatalyst coating, the diameter of the fibers comprising the substrate, and the density of the fiber mass. For example, with 9 μm fiber diameter and a 0.5 μm coating thickness, and with approximately 100 m of this coated fiber per mL of volume, the specific photocatalyst area density can be greater than 50 m²/L. In some embodiments, the specific area density can be greater than 2000 m²/L. The terms “specific area density,” “specific surface area” and “specific surface area density” are used interchangeably in this application. The fiber mass in this example comprises about 1% of the volume it occupies, so that the fiber mass presents low impedance to fluid flow and therefore a low fluid pressure drop in flow across the fiber mass. In other examples, the fiber mass can comprise a higher percent of the volume it occupies, such as about 2% or about 5%. The fiber-to-fiber spacing in this example varies from zero to >1 mm, with average spacing of approximately 0.5 mm, presenting a wide range of effective pore sizes and diverging pathways to water flowing through the fiber mass. This tortuosity of water flow paths results in microturbulence that disrupts the flow as well as the boundary layer at the photocatalyst surface, and thereby improves mass transport of contaminants in the fluid to the reactive photocatalyst surface. Screens, woven meshes and reticulated or foam structures can be used as substitutes, but these other form of substrates are less desirable because they may not be capable of achieving the tortuosity and porosity of this fibrous embodiment. Moreover, the substrate fiber mass that is used in the embodiments in the present disclosure can be readily compressible, so that tortuosity and microturbulence within the fiber mass can be increased by compressing an appropriate quantity of the photocatalyst fiber material into a fluid containment vessel. Through this process, the mean fiber spacing and the resulting porosity of the fiber mass can be adjusted to optimize turbulence at any target rate of flow of fluid through the vessel. The use of a stationary fiber mass with photocatalyst disposed thereon also provides for a uniform and stable distribution of the photocatalyst within the fluid flow, so that the wavelength, and intensity and distribution of the light source(s) illuminating the photocatalyst can be optimized for the photocatalyst density. Furthermore, in one example, the fibrous material comprises or consists of a quartz fiber substrate that is highly transmissive to light over a wide range of wavelengths useful for creating electron-hole pairs in multiple photocatalyst systems. This high light transmissivity provides pathways through the substrate for light to penetrate to the photocatalyst coating even in the presence of strong optical absorption by contaminants in the fluid being treated.

In a further embodiment the spectral distribution of the light used to produce electron-hole pairs in the semiconductor photocatalyst in a photochemical fluid treatment system can be selected to enhance or maximize the absorption depth in the semiconductor and thereby enhance or maximize the photocatalytic surface area in contact with the fluid. A particularly desirable spectral distribution of sources in this embodiment is a narrow band of wavelengths peaking near but below the band gap wavelength of the semiconductor, so that more than half of the power in this spectral distribution is at wavelengths below the band gap wavelength. Because the absorption depth is strongly dependent on wavelength near the band gap wavelength, a narrow spectral distribution also reduces the variation in absorption depths across the spectral distribution and thereby provides for more uniform production of electron-hole pairs throughout the semiconductor photocatalyst. This uniformity also permits the use of higher optical intensities in activating the photocatalyst than have been treated in prior art, with resulting higher photochemical reaction rates.

In a still further embodiment, light sources can be arranged to illuminate the photocatalyst within the photochemical fluid treatment system from plural directions, such as from at least two opposing sides of the semiconductor photocatalyst. The intensity of light propagating through a semiconductor material diminishes with an exponential dependence on the propagation distance. Efficient utilization of light from a single light source results from more full absorption of light within the semiconductor photocatalyst, while maximum photocatalytic process rates require that the intensity be high throughout the photocatalyst. By adding a second source to illuminate the photocatalyst from an opposite side and/or from another direction, the intensity can be made more uniform through the body of the photocatalyst while enhancing the efficient utilization of the light from both sources. Light reflectors can also be used and positioned to enhance the utilization of light from the light source.

In a still further embodiment, light guides can be employed to deliver light from one or more light sources to the photocatalyst within the treatment vessel. These light guides can, for example, be optical wave guides such as solid optical waveguides that propagate light efficiently within the guides, and wherein the light is desirably substantially and/or entirely confined by reflective coatings on the exterior surfaces of the guides or by internal reflection, such as substantial or entire (total) internal reflection. The light guides can be fabricated from any substantially light transmissive optical material, including, but not limited to, quartz, glass, plastics, reinforced plastics, polymers or fluoropolymers. Features on the surfaces of the light guide can be used to scatter or deflect light out of the light guide, such as deflecting the light in directions that are approximately perpendicular to the propagation axis of the guide, to couple the light through light transmissive components (such as windows) in the fluid treatment vessel to the photocatalyst within. Windows or other light transmissive portions on exterior or interior surfaces of the treatment vessel, or on both exterior and interior surfaces, can be used to transmit the light delivered by the light guides into one or more chambers wherein fluid flows through the photocatalyst material activated by the light. Various light guide embodiments can embody one or more of the following features and/or advantages:
The light guides can be positioned to transmit light from the source but to not transmit heat produced by the source, allowing separation of thermal management subsystems used to control source temperature from the operation of a fluid containment vessel.
The light guides can be configured to transform the spatial light emission profiles of the one or more light sources into uniform illumination over the surface of the photocatalyst within the fluid treatment vessel. For efficient photocatalytic process operation the maximum photocatalyst illumination flux is desirably maintained below the limit imposed by sublinear dependence of electron-hole pair formation at higher light intensities. Uniform photocatalyst illumination promotes photochemical fluid treatment at the maximum illumination intensity compatible with efficient system operation.
Use of light guides can reduce losses resulting from reflection of light from the photocatalyst. Measurements have indicated that reflection of UV light from anatase titania on a quartz fiber substrate submerged in water can exceed 40% of the incident light. Direct illumination of this photocatalyst material therefore results in the loss of much of this reflected light to absorption by the source and other structures exterior to the reactor. The light guides are desirably at least partially transmissive to reflected light by design, so that light reflected from the photocatalyst passes back through the light guide so that it can either be coupled into an adjacent photocatalyst chamber or reflected by a minor, or other reflector, back through the light guide to the photocatalyst surface.

Although other light sources, such as mercury discharge lamps, can be used, as an aspect of embodiments, one or more LED sources can be employed for illumination of the one or more photocatalysts of the photochemical fluid treatment system and method of the present disclosure. LEDs are tolerant of a wide range of operating temperatures without significant changes in output power or wavelength, unlike some discharge and other lamps. In another addition, LEDs are available that produce light over narrow wavelength bands that be selected to optimize system performance for a wide range of photochemical fluid treatment systems. LEDs can also be switched on and off quickly, for example in less than one millisecond, much faster than is possible with common mercury discharge lamps. Also, LEDs are resistant to damage from being switched on and off and often operate reliably for tens of thousands of hours, unlike many common mercury discharge lamps that fail after a few thousand hours of continuous operation or sooner if they are switched on and off.

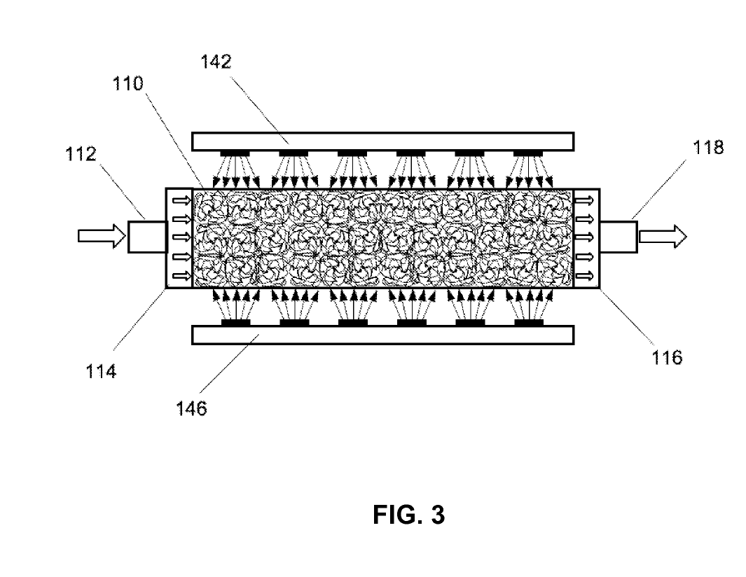

In a still further embodiment, the fluid treated by the photochemical treatment system can be used to cool the light sources used in the system, either before or after treatment. For example, LED light sources can be mounted onto fluid-cooled heatsink blocks (such as at 142 and 146 in FIG. 3) fabricated from one or more metals or other higher thermally conductive materials. The heatsink can be configured to use the treated fluid as its coolant.

In a still further embodiment, a heat exchanger may be used to pre-heat fluid entering the photochemical treatment system while cooling the treated fluid leaving the system. This heat exchanger may comprise separate fluid transfer lines passing through a common thermally conductive housing or block. Photochemical reaction rates increase with modest fluid temperature rise, resulting in improved process performance. Cooling the treated fluid effluent from the system can also serve to improve the quality of this effluent, as is the case for purified drinking water for example.

In a still further embodiment, the effectiveness of the photocatalyst disposed on a fiber substrate, such as quartz fiber, can be enhanced by adhering metal to the photocatalyst, such as by electroless plating of a metal onto the photocatalyst in order to improve the performance of the photocatalyst in disinfection and other photochemical fluid treatment processes. Metal chalcogenide semiconductors, including metal oxides such as titania, exhibit good adhesion to quartz and ceramics. Electroless plating of metals onto such semiconductor coatings after the semiconductor is bonded to the light transmissive fiber substrate avoids compromising the strength of the semiconductor-fiber bond while allowing accurate control of the amount of metal added, while still leaving exposed photocatalyst on the surface of the substrate.

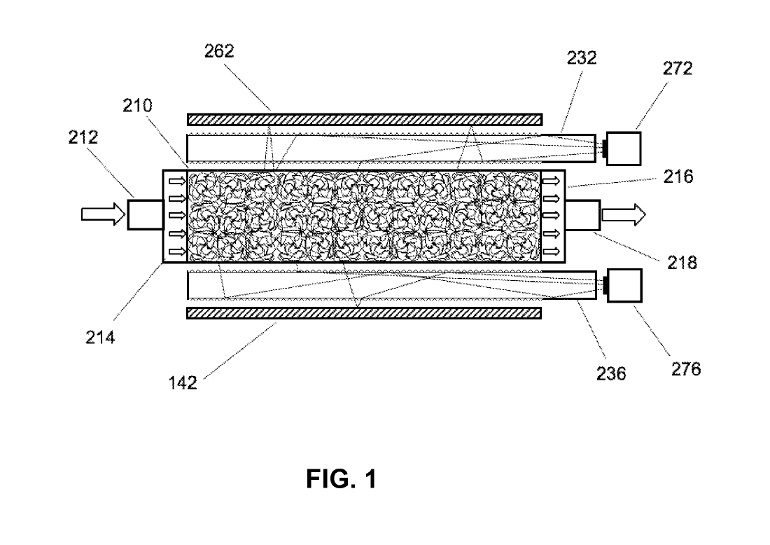

Referring now to an exemplary embodiment in more detail, FIG. 1 is a cut-away view, or vertical sectional view, of an exemplary photochemical fluid treatment reactor with light guides on either side of a fluid flow chamber containing photocatalyst. Fluid flows into inlet 212 and then through influent plenum 214 that desirably spreads the input fluid stream uniformly over the cross section of the interior of the treatment vessel 210 to produce substantially plug flow of the fluid through the treatment vessel. After flowing the length of the treatment vessel, fluid exits the treatment vessel through effluent plenum 216 and outlet 218. Treatment vessel 210 has light transmissive portions, such as windows, forming or incorporated into exterior surfaces of the vessel. Light is transmitted from light sources 272 and 276 through light guides 232 and 236, respectively, to and through the treatment vessel windows. Scattering features in or on the sides of the light guides can be used to scatter light out of the guides, both toward the treatment vessel windows and toward reflectors 262 and 142 that reflect light scattered from the light guides as well as light reflected from the photocatalyst back to the treatment vessel to minimize loss of light. These scattering features can be designed and distributed to provide substantially uniform illumination to and through the windows of the treatment vessel and thereby into the fluid and photocatalyst within the vessel. This cut-away view represents either an exemplary planar photoreactor wherein the vessel, light guides and reflective materials have substantially planar geometries or an exemplary cylindrical reactor wherein the vessel, light guides and reflective materials have substantially cylindrical geometries. The photocatalyst in the flow vessel can fill some or all of the fluid volume within the treatment vessel, as required.

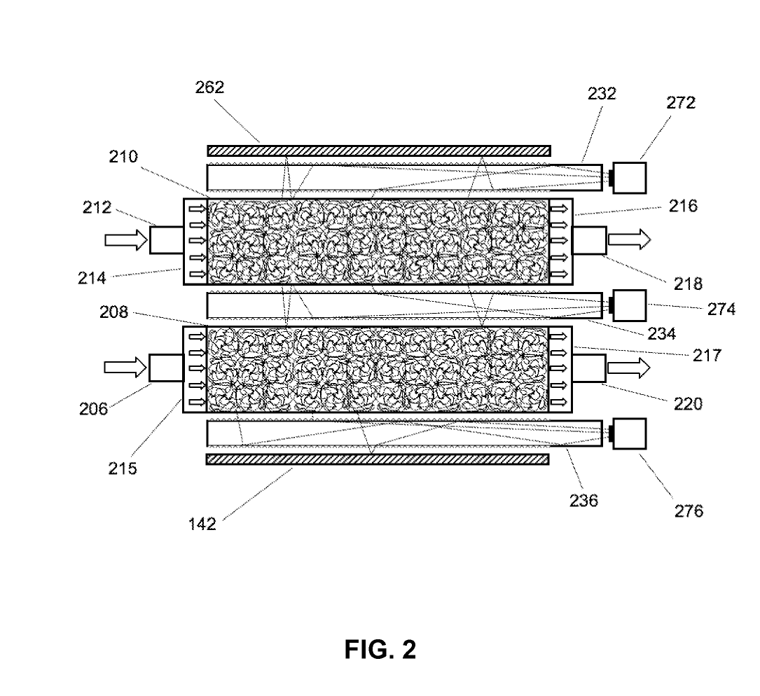

FIG. 2 is a vertical sectional view or cut-away view of another exemplary photochemical fluid treatment reactor with at least one light guide delivering light to fluid flow chambers on more than one side of the light guide. The photoreactor in this cut-away view represents either two substantially planar fluid flow cells separated by at least one light guide that illuminates both cells, together with additional light guides illuminating the flow cells individually, or a fluid flow cell with a substantially annular cross section comprising a flow volume between two substantially concentric cylinders together with light guides both interior to and exterior to the annular fluid flow cell volume. Fluid flows into inlets 212, 206 and then through influent plenums 214, 215 that spread the input fluid stream substantially uniformly over the cross section of the interior of the treatment vessel or vessels 210, 208 to produce substantially plug flow of the fluid through the treatment vessel or vessels. After flowing the length of the treatment vessel or vessels, fluid exits effluent plenums 216, 217 and outlets 218, 220. Treatment vessel 210 has light transmissive portions, such as windows, forming or incorporated into exterior surfaces of the vessel, and light is transmitted from light sources 272 and 274 through light guides 232 and 234, respectively, to and through the treatment vessel windows. Treatment vessel 208 has windows forming or incorporated into exterior surfaces of the vessel, and light is transmitted from light sources 274 and 276 through light guides 234 and 236, respectively, to and through the treatment vessel windows. For the case of a cylindrical fluid flow cell, at least one input, input plenum, effluent plenum and outlet can be used for the treatment vessel, although the geometry may differ from that shown without limiting the scope of the disclosure. The inlet and outlet can, for example, be separated portions of the same housing opening. Also, in the case of batch treatment, an inlet can also function as an outlet. Scattering features in or on the sides of the light guides can be used to scatter light out of the guides, both toward the treatment vessel windows and toward reflectors 262 and 142 that reflect light scattered from the light guides as well as light reflected from the photocatalyst back to the treatment vessel to minimize loss of light. Reflectors are typically eliminated in connection with light guide 234 because light that is scattered or reflected away from one treatment cell window is thereby directed toward another flow cell window. Light guide scattering features can be distributed so as to desirably provide substantially uniform illumination to and through the windows of the treatment vessel or vessels and thereby into the fluid and photocatalyst within the vessel or vessels. The photocatalyst in a flow vessel may fill some or all of the fluid volume within the treatment vessel, as desired.

FIG. 3 shows an example of a photochemical fluid treatment reactor with direct illumination of the photocatalyst by LED arrays (no light guides). Fluid flows into inlet 112 and then through influent plenum 114, which desirably spreads the input fluid stream uniformly over the cross section of the interior of the treatment vessel 110 to produce substantially plug flow of the fluid through the treatment vessel. After flowing the length of the treatment vessel, fluid exits the treatment vessel through effluent plenum 116 and outlet 118. Treatment vessel 110 has light transmissive portions, in this case windows, forming or incorporated into exterior surfaces of the vessel, and is illuminated by light from light sources 142 and 146 through the treatment vessel windows. This cut-away or sectional view represents either a planar reactor, wherein the vessel has a substantially planar geometry, or a cylindrical reactor wherein the vessel has a substantially cylindrical geometry. Other configurations can also be used. The photocatalyst in the flow vessel can fill some or all of the fluid volume within the treatment vessel, as desired.

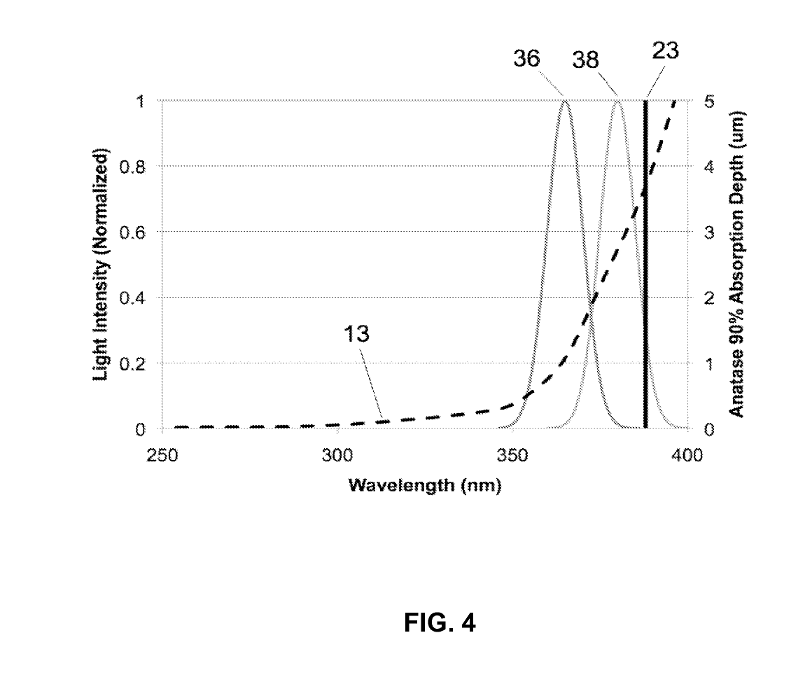

FIG. 4 relates to the optimization of illumination wavelength and mass of photocatalyst desirably used in the embodiments of the present disclosure to provide enhanced or maximum photocatalytic effectiveness. In a photochemical fluid treatment system employing semiconductor photocatalysis, photocatalytic reaction rates improve with increased contact area between the photo-activated photocatalyst and the fluid. The semiconductor photocatalyst material can be in the form of particles disposed on a layer on a substrate within the fluid, or other particle, layer or mass geometries. For all such photocatalyst material geometries, photocatalyst surface area increases with photocatalyst mass in a practical system, so that increasing the mass of photo-activated photocatalyst is expected to improve photocatalytic reaction rates. However, light intensity decreases exponentially as light passes through a semiconductor material, by the relationship:

I(L)=I(0)·e^{-α·L},

where I(L) is the intensity at a depth L within the semiconductor material, I(0) is the intensity at the surface of the semiconductor material and cc is the wavelength dependent absorption constant of the semiconductor material. Therefore, in a practical fluid treatment system employing semiconductor photocatalysis, the semiconductor material thickness has a practical upper limit because semiconductor material at depths beyond this limit is not sufficiently illuminated to function as a practical photocatalyst. This practical semiconductor thickness limit is generally taken to be approximately that which reduces incident intensity by 85-95%. Curve 13 of FIG. 4 illustrates the 90% absorption depth, defined as the thickness of material that reduces the incident intensity by 90% through absorption, for an anatase thin film as a function of wavelength (derived from H. Tang, et al., J. Appl. Phys., vol. 75, no. 4, pp. 2042-7, 1994). Vertical bar 23 locates the 388 nm band gap wavelength of the anatase film; curve 36 shows the spectral distribution of light of a model source peaked at 365 nm; and curve 38 shows the spectral distribution of light of a model source peaked at 385 nm. Curve 13 shows that the 90% absorption depth decreases rapidly with decreasing wavelengths below the band gap wavelength of the semiconductor photocatalyst. At 254 nm, a wavelength produced efficiently by low pressure mercury lamps, this 90% absorption depth is <0.05 μm. At ˜365 nm, a wavelength available from mercury “black light” lamps and from LEDs, the absorption depth averages ˜1 μm as shown by the model LED spectrum of curve 36. For wavelengths just below the band gap wavelength, available from LEDs with narrow spectral bandwidth, the 90% absorption depth increases still further. However, light at wavelengths greater than the semiconductor band gap wavelength is less effective at producing the electron-hole pairs within the semiconductor that drive photochemical processes at the semiconductor surface. Therefore, in order to maximize absorption depth within the semiconductor, and thereby maximize useable photocatalyst mass and surface area, the optimum wavelength band lies just below the band gap wavelength. For example, within the model spectral distribution for an LED with a peak wavelength only 3 nm below the anatase semiconductor band gap as shown in curve 38, the average absorption depth is ˜2.75 times larger than that for a source with peak wavelength 20 nm lower, and most of the narrow spectral distribution is below the band gap wavelength and thus capable of efficient production of electron-hole pairs for photocatalytic activity. Moreover, as the absorption depth for light within the photocatalyst increases, the maximum practical incident light intensity at the photocatalyst surface increases commensurately. Therefore, optimizing the photoactivation wavelength band maximizes the amount of light that can efficiently produce electron-hole pairs in the semiconductor photocatalyst and thereby increases photochemical process rates at the photocatalyst-fluid interface. In fact, curve 13 demonstrates that effective rates of photocatalytic electron-hole pair production in anatase titanium dioxide can be more than 100 times greater at 385 nm than at 254 nm.

FIG. 4 therefore illustrates the advantage of using a narrow bandwidth source such as an LED, with spectral emission in a wavelength band immediately below the semiconductor band gap wavelength, to maximize activated photocatalyst surface area in contact with a fluid in a photochemical fluid treatment system. The use of a narrow linewidth light source with wavelength distribution below but near the band gap wavelength to optimize or enhance the generation of electron-hole pairs in a semiconductor photocatalyst can be applied to the illumination of any semiconductor photocatalyst in a photochemical fluid treatment system.

In some embodiments, the light sources can desirably produce light wherein at least 50% or at least 75% of the light has a wavelength that is between the band gap wavelength of the photocatalyst and the band gap wavelength minus 30 nm or minus 20 nm. Light having such concentrated bandwidths can achieve greater penetration depths within the photocatalyst/substrate.

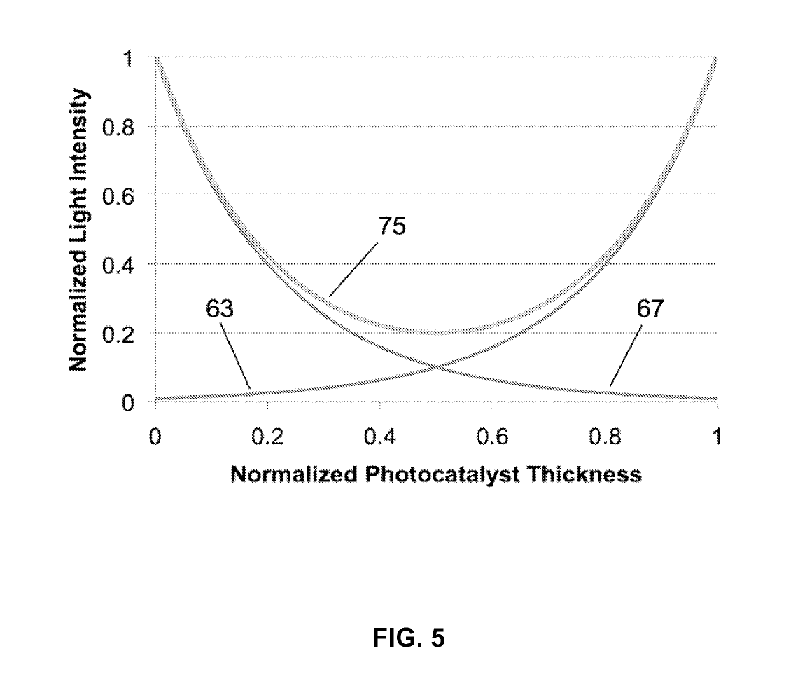

FIG. 5 relates to the advantage of illuminating a photocatalyst from opposing sides to optimize photocatalyst performance with high optical efficiency. Illumination of a photochemical treatment cell by a light source on one side results in an exponential decrease in light intensity across the cell, as shown by curve 67. A cell optimized to use most of the incident light from one side only will have very low intensity on the opposite side of the cell to avoid having light lost at the far side of the cell. By adding illumination from a similar light source on the other side of the cell, as shown by curve 63, the intensity across the cell can be maintained at a higher level at a greater depths of penetration as shown by curve 75.

In some embodiments, there can be an optimum quantity of semiconductor photocatalyst within the fluid being treated, an optimum density of photocatalyst (quantity/volume) within the fluid being treated, and an optimum range of wavelengths from the UV source to activate the photocatalyst, and all three of these parameters can be interdependent. Accordingly, an exemplary process can comprise optimizing a photochemical treatment system by optimizing one or more of these parameters.

It some embodiments, it can be preferable that light penetrates through the fluid and the photocatalyst sufficiently to activate all, or substantially all, of the photocatalyst within the fluid. Assuming that the fluid is substantially transmissive to the light (as is the case for filtered water at wavelengths in the near ultraviolet—320-400 nm—for example), light traveling through fluid/photocatalyst is partially absorbed by the photocatalyst, with the remainder of the light transmitted/scattered by the photocatalyst and its substrate. The penetration depth of a given fluid/photocatalyst medium can therefore be inversely related to the absorption of the photocatalyst—lower absorption can result in higher UV transmission and greater penetration of the medium. Because the fiber substrate of the photocatalyst can be substantially transmissive to 320-400 nm wavelengths, light in this wavelength range that is not absorbed in the photocatalyst coating on this substrate can be substantially transmitted through the substrate and can pass through the fluid to another coated fiber. This process can repeat until the optical energy is absorbed by photocatalyst or transmitted out of the medium.

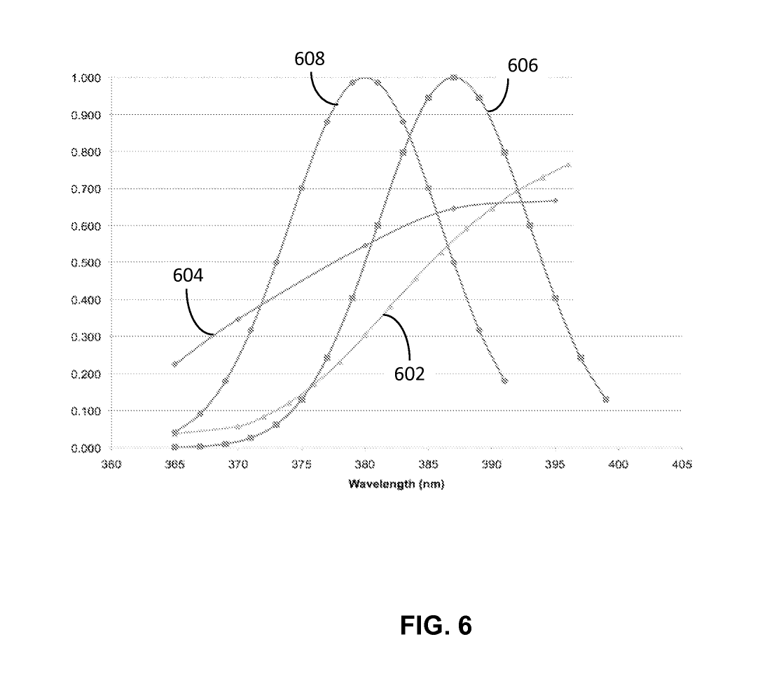

FIG. 6 shows at 602 the relative transmission of a range of near-UV light through an exemplary semiconductor photocatalyst on a quartz substrate in water. In comparison, FIG. 6 also shows at 604 an example of the relative transmission spectrum of anatase TiO₂ films coated onto glass. The transition from weak optical absorption (high transmission) at longer wavelengths to strong optical absorption (low transmission) at shorter wavelengths occurs because there is a bandgap energy and a corresponding bandgap wavelength associated with any semiconductor. For so-called direct-gap semiconductors, such as anatase TiO₂, optical illumination at wavelengths substantially greater than the bandgap wavelength of a perfect semiconductor crystal is not absorbed, and wavelengths substantially less than the bandgap wavelength are not absorbed. For example, the bandgap wavelength λ_{g} of crystalline anatase is about 388 nm. The approximately 30 nm width of the transition from high transmission to low transmission for the exemplary semiconductor photocatalyst in water, as shown in FIG. 6, results in part from the high specific surface area of the semiconductor coating—this material is not a single crystal, but is instead many nanocrystalline elements with a very large surface area. Due to the nanocrystalline structure of this photocatalyst there will be slight variations in the band gap from the nominal band gap of crystalline material. The term “band gap of approximately λ_{g}” is used herein to mean the broadened range of band gaps of the nanocrystalline photocatalyst including such deviations. This broadened spectral transition region presents an opportunity to select illumination wavelengths that result in controlled penetration depths through a given amount of photocatalyst. For a given source spectral distribution (full width at half maximum, for example), moving the peak wavelength of the illumination close to the band gap wavelength can increase the penetration depth and allow treatment of a larger volume with a fixed illumination area. For example, FIG. 6 includes approximate spectra (there is some variation from LED to LED, but the full width at half maximum of an LED spectrum is typically 10-15 nm) of LEDs peaked at 380 nm (at 608) and 387 (at 606). Note that, for these two LEDs, the spectral energy of the 380 nm LED is contained in a wavelength range that corresponds with a lower transmission (higher absorption) wavelength of the photocatalyst than is the case with the 387 nm LED. For this reason, the 387 nm LED can have significantly higher transmission, and thereby a greater penetration depth through a given density of the photocatalyst.

For the case of fluid being treated while flowing through a treatment chamber, microturbulence in flow through the photocatalyst/substrate material can enhance mass transfer of contaminants to the surface of the semiconductor photocatalyst and thereby enhance the rate of removal of these contaminants from the fluid by photochemical means. However, increasing photocatalyst/substrate density can impede fluid flow and thereby increase pressure drop across the treatment chamber and reduce flow rates. The density of the photocatalyst and substrate within the fluid being treated desirably are selected to balance microturbulence in flow through the medium with pressure drop in across the medium to maximize overall energy efficiency.

Furthermore, for a practical system, the total illumination flux can be limited by the efficiency of the light source (electrical-to-optical conversion efficiently in LEDs, for example), the coupling efficiency in delivering light from the light source to the photocatalyst, and/or the maximum illumination flux compatible with linear response of the photochemical system (resulting from nonlinear increase of recombination of electron-hole pairs photogenerated in the semiconductor at higher intensities). Operation at or near this maximum illumination flux can be preferable for cost efficiency. This maximum illumination flux can be determined for a specific light source by increasing the flux until the resulting photochemical performance does not increase linearly with flux. With optical energy flux defined by this linearity constraint and total illuminated area defined by available optical power, the illuminated area of a semiconductor photocatalytic system can therefore be determined by the available optical power.

In embodiments where a preferred photocatalyst density in the fluid is defined by a preferred balance of microturbulence and pressure drop, a penetration depth is defined by an illumination source spectrum at that photocatalyst density and an illuminated area is defined by available optical power, the preferred treatment volume can then be the product of this illuminated area and the penetration depth.

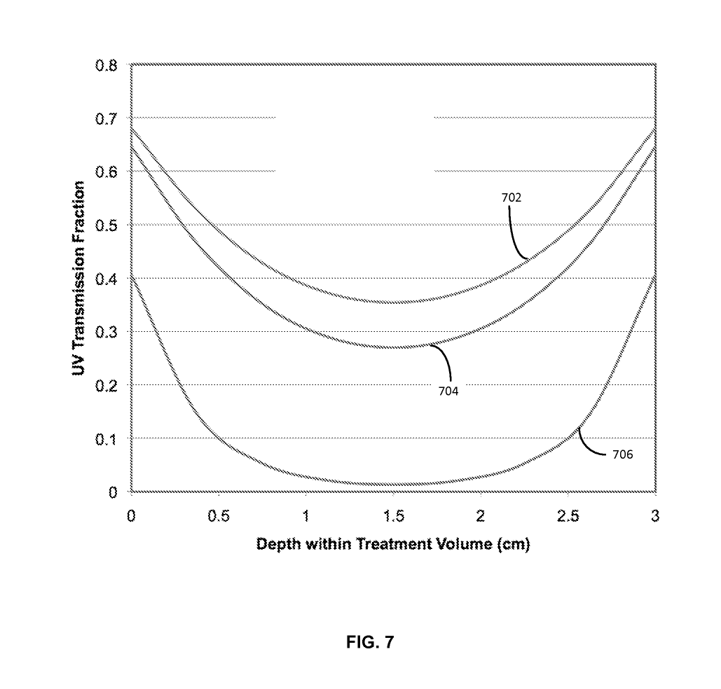

FIG. 7 shows light transmission fraction versus light penetration depth within the treatment volume for an exemplary photoreactor embodiment having a 3 cm treatment volume thickness being illuminated from two opposite sides and a TiO₂ photocatalyst with a specific area density of approximately 3200 m²/L. The fraction of light from the source transmitted to the 1.5 cm center of the treatment volume is lowest while the fraction of light from the source transmitted to the 0 cm and 3 cm edges of the treatment volume is greatest. Because some of the light is lost before reaching the treatment volume, the transmission fractions are less than 1 even at the 0 cm and 3 cm edges of the treatment volume. Line 702 represents light from a source having a 388 nm peak wavelength, line 704 represents light from a source having a 385 nm peak wavelength, and line 706 represents light from a source having a 379 nm peak wavelength. FIG. 7 shows that light from a source having a longer peak wavelength (e.g., line 702) can penetrate deeper into the treatment volume with less loss than light from a source having a shorter peak wavelength (e.g., line 706). For example, more than 25% of the light from the 388 nm peak source is transmitted to the 1.5 cm center of the treatment volume, whereas less than 5% of the light from the 379 nm peak source is transmitted to the 1.5 cm center of the treatment volume. Note that 388 nm is the approximate bandgap wavelength of the TiO₂ photocatalyst and thus, it can be preferable to use light closer to the bandgap wavelength of the photocatalyst to achieve greater depth penetration of the treatment volume.

In some embodiments of a photochemical fluid treatment system, cost effectiveness considerations can result in a preferred operation at the maximum practical illumination source optical power output. In addition, for practical considerations, the performance of the system can depend linearly on optical power at lower optical power output. In some embodiments used with a fluid stream wherein contamination levels in the influent fluid stream vary over time, the capacity of the system can be sufficient to remove a sufficient fraction of the contaminants at the maximum anticipated contamination level to meet selected effluent contamination requirements for the system. However, when influent contamination levels fall, the optical power output (and the system power consumption) can be reduced as appropriate to continue to meet effluent contaminant requirements with lower input power consumption and thereby lower operating costs. With variable output light sources, adjusting the optical output power can be readily accomplished by adjust input power. For example, LED output power can be adjusted by adjusting input DC electrical current or by modulating the duty cycle of input pulsed electrical current.

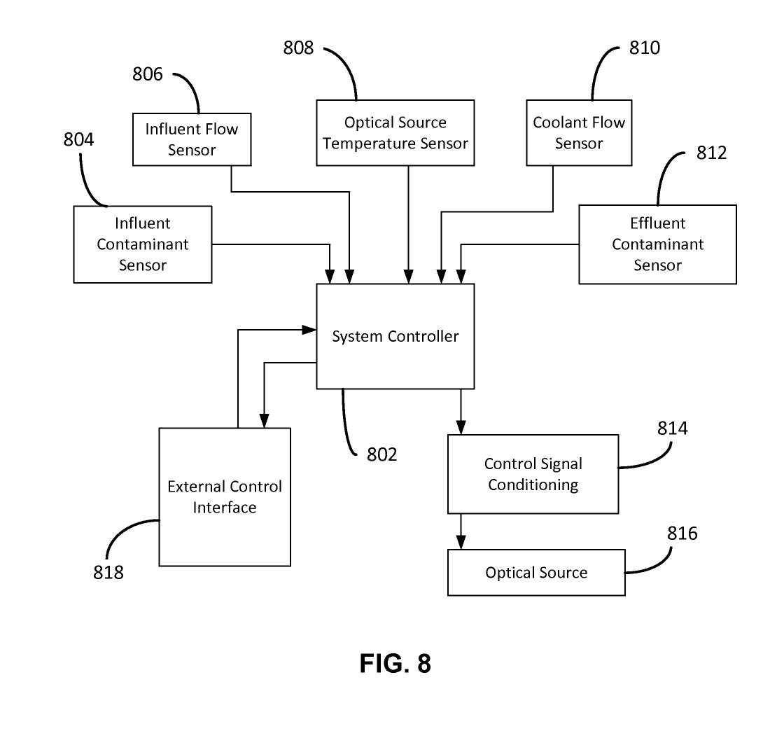

FIG. 8 shows a block diagram representing an exemplary control system for a fluid treatment photoreactor. A system controller 802, such as a programmed microprocessor, can interact with various system sensors and other devices to control selected system parameters. For example, a contaminant sensor 804 can monitor influent contaminant concentration. This parameter can be used to determine the photochemical performance level of the system and the resulting optical output power needed to keep effluent contaminant concentrations below required limits. This influent sensor 804 can also detect influent contaminant concentrations exceeding the maximum treatment capacity of the system and alert operators as appropriate. A contaminant sensor 812 monitoring effluent contaminant concentrations can also be included, such as to determine required system photochemical performance and adjust optical output power accordingly. Sensors 804, 812 in both influent and effluent streams can continually assure both optimized system performance and energy consumption. Suitable sensors for this purpose can include specific chemical sensors for removal of specific contaminants, as well as total organic carbon (TOC) sensors that monitor all organic carbon. Digital and/or analog control circuits that receive input signals from such sensors can perform appropriate adjustments in output signals controlling optical power or other operating parameters as appropriate.

LEDs and other optical sources typically have maximum operating temperatures to assure device lifetimes are not compromised. Temperature sensors 808, such as thermistors and/or thermocouples, can monitor device temperatures to assure operating temperatures do not exceed these limits. Flow sensors 806, 810 can detect influent flow and coolant flow, respectively. Other flow sensors can also detect the flow of coolant to/from optical sources and other temperature-sensitive components. Digital and/or analog control circuits that receive input signals from such sensors can also perform appropriate adjustments in output signals controlling power to components to avoid damage to the components and/or system. FIG. 8 shows an exemplary output signal from the system controller through control signal conditioning block 814 and then to an optical light source 816 to control the power to the optical source. Digital and/or analog control signals can be interchanged with an external controller at external control interface 818 to allow the external controller to control operating parameters and/or to alert the external controller of warning, error or other conditions as appropriate.

In one exemplary embodiment, if a sensor indicates that a light source temperature exceeds a threshold, such as a predetermined threshold, a controller can reduce or turn off power to the light source in order to reduce heat generated by the light source. For LEDs, this can mean controlling the current supplied to the LEDs. The controller can also alert a user or other system controller by light, sound or electric signal through appropriate system output ports.

In another exemplary embodiment, if a sensor indicates that an influent or effluent temperature is beyond a threshold, such as a predetermined threshold, such as above 40° C., the controller can turn off or reduce power or current to one or more light sources in order to reduce heat generated by the light source. The controller can also alert a user or other system controller by light, sound or electric signal through appropriate system output ports.

In yet another exemplary embodiment, if a sensor indicates that a purity of the fluid is below a threshold, such as a predetermined threshold, the controller can turn on or increase power or current to one or more light sources in order to increase the purification rate. If the sensor indicates that the purity of the fluid is above a desired purity threshold, the controller can decrease power or current to the light source to reduce power consumption. If the sensor indicates that the purity of the fluid is below a desired purity threshold with the lights sources operated at maximum power, the controller can alert a user or other system controller by light, sound or electric signal through appropriate system output ports. Alternatively, the flow rate can be reduced to enhance the purity of the treated fluid to achieve the threshold.

In yet another exemplary embodiment, if a sensor indicates that a fluid flow rate is below a threshold, such as a predetermined threshold, such that insufficient cooling can result in system performance problems, the controller can alert a user or other system controller by light, sound or electric signal through appropriate system output ports. If a sensor indicates that a fluid flow rate is above a threshold, such that the purification rate may be insufficient, the controller can alert a user or other system controller by light, sound or electric signal through appropriate system output ports.

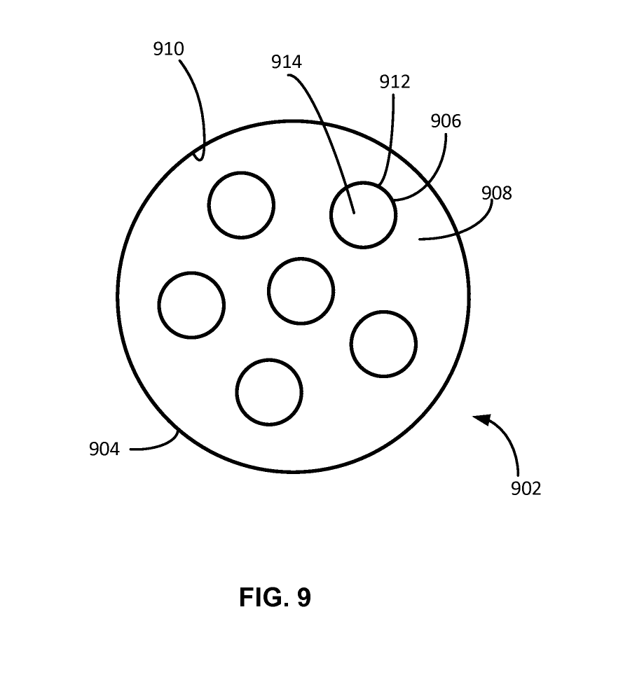

FIG. 9 is a cut-away or sectional view of another exemplary photochemical fluid treatment reactor 902 having fluid flow chamber 908 containing photocatalyst constrained between an inner surface 910 of an outer cylindrical wall 904 and outer surface(s) 912 of one or more inner cylindrical walls 906. The outer wall 904 and the inner walls 906 can comprise at least partially light transmissive portions, or windows (not shown). The photoreactor 902 can further comprise light guides 914 within the inner walls 906 that transmit light from light sources (not shown) through the light guides 914, to and through the windows of the inner walls 906, and into the fluid flow chamber 908. Similarly, the photoreactor 902 can further comprise outer light guides outside of the outer wall 904 that transmit light from light sources through the outer light guides, to and through the windows of the outer wall 904, and into the fluid flow chamber 908. The light guides can further comprise scattering features to scatter light out of the guides. The inner surface 910 of the outer wall 904 can also comprise a reflective material to reflect light from the fluid back into fluid. The cylindrical shape of the inner and outer walls can provide sufficient strength to contain fluid with the flow chamber 908 at a predetermined maximum pressure, such as 125 psi.

The reactor 902 can also comprise a removable and replaceable cartridge. Such a cartridge can be defined by the outer cylindrical wall 904 and a pair of end walls comprising an input and output means. The cartridge can contain the photocatalyst and light guides, which can be removed and replaced along with the cartridge, such as when the photochemical performance drops below a predetermined treatment effectiveness level. Portions of the cartridge, such as the inner and outer walls 904 and 906 and the inner light guides 914, can be reused or recycled with fresh photocatalyst.

In view of the many possible embodiments to which the principles of our invention may be applied, it should be recognized that illustrated embodiments are only examples of the invention and should not be considered a limitation on the scope of the invention. Rather, the scope of the invention is defined by the following claims. We therefore claim as our invention all that comes within the scope and spirit of these claims.

We claim:

1.-52. (canceled)

53. A fluid treatment photoreactor, comprising:
a housing comprising a fluid inlet for receiving fluid to be treated and a fluid outlet for delivering treated fluid, the housing defining a fluid flow path between the fluid inlet and the fluid outlet;
an at least partially light transmissive substrate disposed within the housing in the fluid flow path;
a semiconductor photocatalyst disposed on the substrate and having a band gap wavelength λ_{g}, the photocatalyst having a specific surface area of more than 50 square meters per liter of fluid in the portion of the fluid flow path containing the substrate; and at least one light source that produces light, wherein at least 50% of the light from the at least one light source has a wavelength that is between (λ_{g}-30 nm) and λ_{g}.

54. A fluid treatment photoreactor according to claim 1, wherein the at least partially light transmissive substrate comprises a fiber material through which fluid can flow.

55. A fluid treatment photoreactor according to claim 1, wherein the housing includes at least one light transmitting portion operable to guide fluid flow through the photoreactor while also transmitting the light produced by the at least one light source into an illuminated portion of the fluid with less than a 10% loss of light through the light transmitting portion.

56. A fluid treatment photoreactor according to claim 1, wherein the housing constrains the illuminated portion of the fluid to have a substantially constant thickness at least in the region of the housing where the fluid is illuminated by the at least one light source.

57. A fluid treatment photoreactor according to claim 4, wherein the housing comprises at least first and second fluid guiding surfaces, and wherein the illuminated portion of the fluid with a substantially constant thickness is confined between the at least first and second fluid guiding surfaces of the housing.

58. A fluid treatment photoreactor according to claim 5, wherein the housing comprises at least first and second spaced apart wall sections and the at least first and second fluid guiding surfaces comprise a first planar surface of the first wall section and a second planar surface of the second wall section, the first and second surfaces being substantially parallel to one another.

59. A fluid treatment photoreactor according to claim 5, wherein the housing comprises at least first and second coaxial right cylindrical spaced apart wall sections, the at least first and second fluid guiding surfaces comprising respective portions of the at least first and second cylindrical wall sections.

60. A fluid treatment photoreactor according to claim 1, wherein the at least one light source comprises at least one LED.

61. A fluid treatment photoreactor according to claim 1, further comprising at least one reflector disposed outside of the fluid flow path and in a position to reflect light scattered from the fluid, the photocatalyst, the substrate, or the housing back into the fluid.

62. A fluid treatment photoreactor according to claim 1, wherein the housing further comprises at least one light transmissive light guide operable to convey light from the at least one light source through the at least one light transmitting portion of the housing and into fluid flowing in the fluid flow path to illuminate at least a portion of the fluid within the housing.

63. A fluid treatment photoreactor according to claim 10, wherein the at least one light guide comprises surface features operable to scatter light from the light guide, and wherein the at least one light guide is positioned inside or outside the housing such that light scattered from the surface features of the light guide illuminates at least a portion of the fluid within the housing through the at least one light transmitting portion of the housing.

64. A fluid treatment photoreactor according to claim 1, wherein the combined volume of the photocatalyst and the substrate is less than 5% of the fluid volume in the fluid flow path within the housing.

65. A fluid treatment photoreactor according to claim 1, further comprising a metal deposited onto the photocatalyst disposed on the substrate.

66. A fluid treatment photoreactor according to claim 1, further comprising at least one heat sink cooled by flow of a fluid through the heat sink, and wherein the at least one light source is mounted on the at least one heat sink.

67. A fluid treatment photoreactor according to claim 14, wherein the heat sink comprises a cooling fluid flow passageway and wherein fluid treated by the photoreactor is directed through the cooling fluid flow passageway so as to cool the heat sink.

68. A fluid treatment photoreactor according to claim 1, further comprising at least one filter module positioned upstream from the fluid inlet and/or downstream from the fluid outlet and operable to remove particulates from the fluid to be treated.

69. A fluid treatment photoreactor according to claim 1, further comprising a controller operable to control at least a first operating parameter of the photoreactor, at least one sensor coupled to the controller and operable to sense at least a second operating parameter of the photoreactor and produce an output signal corresponding to the sensed at least second operating parameter, the output signal being communicated by the controller to effect control of the at least first operating parameter.

70. A fluid treatment photoreactor according to claim 17, wherein:
the first operating parameter comprises at least one of: an electrical current supplied to the at least one light source, a fluid flow rate within the fluid flow path, and a cooling fluid flow rate through a heat sink; and
the second operating parameter comprises at least one of: a temperature of the at least one light source, a temperature of the fluid in at least one location within the photoreactor, a purity of the fluid in at least one location within the photoreactor, and a turbidity of the fluid in at least one location within the photoreactor.

71. A method for treating fluid, comprising:
exposing a fluid to be treated to a semiconductor photocatalyst disposed on a light transmissive fiber substrate, the photocatalyst comprising a band gap wavelength λ_{g}, the photocatalyst having a specific surface area of more than 50 square meters per liter of fluid; and
illuminating at least a portion of the fluid to be treated and at least a portion of the photocatalyst within the fluid with light to activate at least two photochemical fluid treatment processes, at least 50% of the light comprising wavelengths between (λ_{g}-30 nm) and λ_{g}.

72. A method according to claim 19, wherein the at least two photochemical fluid treatment processes are selected from photolysis, photocatalytic oxidation, photocatalytic reduction, photodisinfection, and photoadsorption.
